(19) United States
(12) Patent Application Publication
(10) Pub. No.: US 2025/0103209 A1
(43) Pub. Date: Mar. 27, 2025

(54) MEMORY SYSTEM, OPERATING METHOD OF MEMORY SYSTEM, AND OPERATING METHOD OF MEMORY CONTROLLER

(71) Applicant: SAMSUNG ELECTRONICS CO., LTD., Suwon-si (KR)

(72) Inventor: Insoo KIM, Suwon-si (KR)

(73) Assignee: SAMSUNG ELECTRONICS CO., LTD., Suwon-si (KR)

(21) Appl. No.: 18/891,579

(22) Filed: Sep. 20, 2024

(30) Foreign Application Priority Data
Sep. 21, 2023 (KR) 10-2023-0126408
Dec. 27, 2023 (KR) 10-2023-0193173
Sep. 11, 2024 (KR) 10-2024-0124236

(51) Int. Cl. G06F 3/06

(52) U.S. Cl. CPC G06F 3/0611; G06F 3/0634; G06F 3/0673

(57) ABSTRACT

A memory system includes a memory device, and a memory controller connected to the memory device. The memory controller is configured to analyze a pattern of the suspend schedule command a plurality of times to obtain a plurality of analysis results, select an operating mode from among a plurality of operating modes based on the plurality of analysis results, determine a suspend schedule based on the operating mode, and perform a memory operation on the memory device based on the suspend schedule. The plurality of operating modes including a latency mode and a throughput mode. The memory operation including at least one of a read operation or a write operation.

### CROSS-REFERENCE TO RELATED APPLICATIONS

This application claims benefit of priority under 35 U.S.C. § 119 to Korean Patent Application No. 10-2023-0126408, filed on Sep. 21, 2023, Korean Patent Application No. 10-2023-0193173, filed on Dec. 27, 2023, and Korean Patent Application No. 10-2024-0124236, filed on Sep. 11, 2024, in the Korean Intellectual Property Office, the disclosures of which are incorporated by reference herein in their entireties.

### BACKGROUND

### 1. Field

The present disclosure relates generally to a memory system, an operating method of the memory system, and an operating method of a memory controller, and more particularly, to a memory system capable of regulating a suspend operation after a write operation and before a read operation is performed.

### 2. Description of Related Art

Related memory systems may have focused on attempting to prevent latency in read operations when transmitting commands. However, when attempting to improve latency of read operations, an overall data throughput of the memory system may be reduced due to frequent suspend operations.

There exists a need for further improvements in memory systems, as the need for improvements in latency of read operations may be constrained by an overall data throughput of the memory system. Improvements are presented herein. These improvements may also be applicable to other semiconductor devices.

### SUMMARY

One or more example embodiments of the present disclosure provide a memory system capable of increasing data throughput without causing latency in data read operations, by analyzing patterns of read operation commands and write operation commands in real time and appropriately scheduling suspend operations.

According to an aspect of the present disclosure, a memory system includes a memory device, and a memory controller connected to the memory device. The memory controller is configured to analyze a pattern of the suspend schedule command a plurality of times to obtain a plurality of analysis results, select an operating mode from among a plurality of operating modes based on the plurality of analysis results, determine a suspend schedule based on the operating mode, and perform a memory operation on the memory device based on the suspend schedule. The plurality of operating modes including a latency mode and a throughput mode. The memory operation including at least one of a read operation or a write operation.

According to an aspect of the present disclosure, an operating method of a memory system for managing a suspend schedule of a memory device includes analyzing a pattern of the suspend schedule command a plurality of times to obtain a plurality of analysis results, selecting an operating mode from among a plurality of operating modes based on the plurality of analysis results, determining a suspend schedule based on the operating mode, and performing a memory operation on the memory device based on the suspend schedule. The plurality of operating modes including a latency mode and a throughput mode. The memory operation including at least one of a read operation or a write operation.

According to an aspect of the present disclosure, an operating method of a memory controller for managing a suspend schedule of a memory device includes analyzing a pattern of the suspend schedule command a plurality of times to obtain a plurality of analysis results, selecting an operating mode from among a plurality of operating modes based on the plurality of analysis results, determining a suspend schedule based on the operating mode; and performing a memory operation on the memory device based on the suspend schedule. The plurality of operating modes including a latency mode and a throughput mode. The memory operation including at least one of a read operation or a write operation.

Additional aspects may be set forth in part in the description which follows and, in part, may be apparent from the description, and/or may be learned by practice of the presented embodiments.

### BRIEF DESCRIPTION OF DRAWINGS

The above and other aspects, features, and advantages of certain embodiments of the present disclosure may be more apparent from the following description taken in conjunction with the accompanying drawings, in which:

FIG. 1 is a block diagram of a memory system, according to an embodiment;

FIG. 2 is a block diagram of a host, according to an embodiment;

FIG. 3A illustrates a command input by a host in a latency mode, according to an embodiment;

FIG. 3B illustrates data throughput when a memory system operates in a latency improvement mode (or a latency mode), according to an embodiment;

FIG. 4A illustrates a command input by a host in a throughput mode, according to an embodiment;

FIG. 4B illustrates data throughput when a memory system operates in a data throughput improvement mode (or a throughput mode), according to an embodiment;

FIG. 5 illustrates a scheduling part of a command, according to an embodiment;

FIG. 6 illustrates analysis of a scheduling pattern at a predetermined period, according to an embodiment;

FIG. 7 illustrates data throughput in a latency mode and a throughput mode, according to an embodiment;

FIG. 8 is a flowchart of an operating method of a memory system, according to an embodiment;

FIG. 9 is a flowchart of a method of determining a suspend schedule based on a throughput mode in an operating method of a memory system, according to an embodiment;

FIG. 10 is a flowchart of a method of determining a suspend schedule based on a latency mode in an operating method of a memory system, according to an embodiment;

FIGS. 11 and 12 are diagrams illustrating a three-dimensional (3D) vertical NAND (V-NAND) structure that may be applied to a memory device, according to an embodiment; and

FIG. 13 is a cross-sectional view illustrating a memory device having a bonding V-NAND (B-VNAND) structure, according to an embodiment.

FIG. 14 is a block diagram of a storage system according to an example embodiment.

### DETAILED DESCRIPTION

The following description with reference to the accompanying drawings is provided to assist in a comprehensive understanding of embodiments of the present disclosure defined by the claims and their equivalents. Various specific details are included to assist in understanding, but these details are considered to be exemplary only. Therefore, those of ordinary skill in the art may recognize that various changes and modifications of the embodiments described herein may be made without departing from the scope and spirit of the disclosure. In addition, descriptions of well-known functions and structures are omitted for clarity and conciseness.

With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wired), wirelessly, or via a third element.

It is to be understood that when an element or layer is referred to as being “over,” “above,” “on,” “below,” “under,” “beneath,” “connected to” or “coupled to” another element or layer, it may be directly over, above, on, below, under, beneath, connected or coupled to the other element or layer or intervening elements or layers may be present. In contrast, when an element is referred to as being “directly over,” “directly above,” “directly on,” “directly below,” “directly under,” “directly beneath,” “directly connected to” or “directly coupled to” another element or layer, there are no intervening elements or layers present.

The terms “upper,” “middle”, “lower”, and the like may be replaced with terms, such as “first,” “second,” third” to be used to describe relative positions of elements. The terms “first,” “second,” third” may be used to describe various elements but the elements are not limited by the terms and a “first element” may be referred to as a “second element”. Alternatively or additionally, the terms “first”, “second”, “third”, and the like may be used to distinguish components from each other and do not limit the present disclosure. For example, the terms “first”, “second”, “third”, and the like may not necessarily involve an order or a numerical meaning of any form.

As used herein, when an element or layer is referred to as “covering”, “overlapping”, or “surrounding” another element or layer, the element or layer may cover at least a portion of the other element or layer, where the portion may include a fraction of the other element or may include an entirety of the other element. Similarly, when an element or layer is referred to as “penetrating” another element or layer, the element or layer may penetrate at least a portion of the other element or layer, where the portion may include a fraction of the other element or may include an entire dimension (e.g., length, width, depth) of the other element.

Reference throughout the present disclosure to “one embodiment,” “an embodiment,” “an example embodiment,” or similar language may indicate that a particular feature, structure, or characteristic described in connection with the indicated embodiment is included in at least one embodiment of the present solution. Thus, the phrases “in one embodiment”, “in an embodiment,” “in an example embodiment,” and similar language throughout this disclosure may, but do not necessarily, all refer to the same embodiment. The embodiments described herein are example embodiments, and thus, the disclosure is not limited thereto and may be realized in various other forms.

It is to be understood that the specific order or hierarchy of blocks in the processes/flowcharts disclosed are an illustration of exemplary approaches. Based upon design preferences, it is understood that the specific order or hierarchy of blocks in the processes/flowcharts may be rearranged. Further, some blocks may be combined or omitted. The accompanying claims present elements of the various blocks in a sample order, and are not meant to be limited to the specific order or hierarchy presented.

The embodiments herein may be described and illustrated in terms of blocks, as shown in the drawings, which carry out a described function or functions. These blocks, which may be referred to herein as units or modules or the like, or by names such as device, logic, circuit, controller, counter, comparator, generator, converter, or the like, may be physically implemented by analog and/or digital circuits including one or more of a logic gate, an integrated circuit, a microprocessor, a microcontroller, a memory circuit, a passive electronic component, an active electronic component, an optical component, and the like. Alternatively or additionally, these blocks and/or the functionality of these blocks may be implemented by computer software and/or a combination of electronic hardware and computer software. Whether the functionality of these blocks is implemented in hardware or software may depend upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be and/or may include a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in the present disclosure and their structural equivalents thereof, or in any combination thereof. Implementations of the subject matter described in the present disclosure also may be implemented as one or more computer programs (e.g., one or more modules of computer program instructions) encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media may include both computer storage media and communication media including any medium that may be enabled to transfer a computer program from one place to another. A storage media may be any available media that may be accessed by a computer. By way of example, and not limitation, such computer-readable media may include random access memory (RAM), read-only memory (ROM), electrically erasable programmable read-only memory (EEPROM), compact disc ROM (CD-ROM) or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes, but is not limited to, compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

In the present disclosure, the articles “a” and “an” are intended to include one or more items, and may be used interchangeably with “one or more.” Where only one item is intended, the term “one” or similar language is used. For example, the term “a processor” may refer to either a single processor or multiple processors. When a processor is described as carrying out an operation and the processor is referred to perform an additional operation, the multiple operations may be executed by either a single processor or any one or a combination of multiple processors.

As used in the present disclosure, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

As used herein, each of the terms “Si₃N₄”, “SiO₂”, and the like may refer to a material made of elements included in each of the terms and is not a chemical formula representing a stoichiometric relationship

Hereinafter, various embodiments of the present disclosure are described with reference to the accompanying drawings.

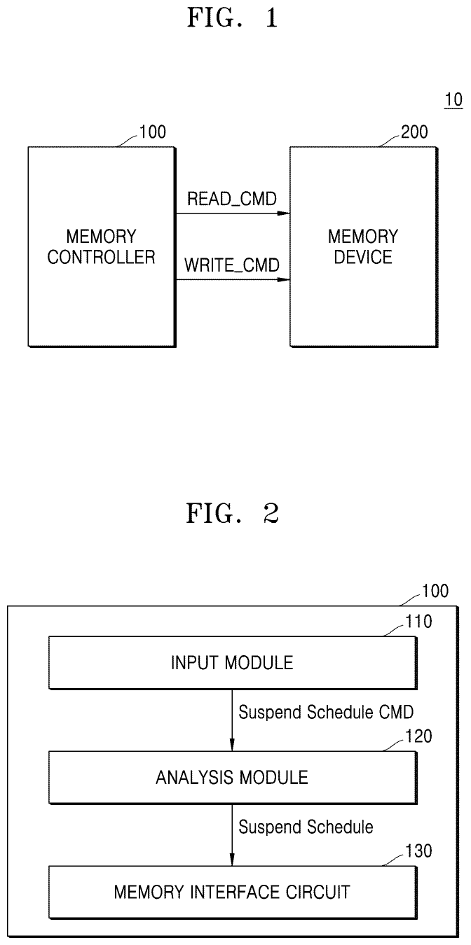

FIG. 1 is a block diagram of a memory system 10, according to an embodiment.

Referring to FIG. 1, the memory system 10, according to an embodiment, may include a memory controller 100 and a memory device 200. Hereinafter, in the present disclosure, the memory system 10 may have the same technical meaning as storage device. The memory controller 100 of the memory system 10, according to an embodiment, may transmit a command WRITE_CMD to the memory device 200, which may cause the memory device 200 to perform a write operation. Alternatively or additionally, the memory controller 100 of the memory system 10 may transmit a read command READ_CMD to the memory device 200, which may cause the memory device 200 to perform a read operation. Hereinafter, in the present disclosure, the memory controller 100 may refer to a hardware device.

The memory controller 100, according to an embodiment, may manage a suspend schedule for the memory device 200. A suspend operation, according to an embodiment, may refer to an operation of stopping transmission of the write command WRITE_CMD and the read command READ_CMD before the read command READ_CMD starts after the write command WRITE_CMD stops. The suspend schedule, according to an embodiment, may refer to an operation of scheduling a suspend operation by determining the order of the previous write command WRITE_CMD and the read command READ_CMD.

The memory controller 100, according to an embodiment, may manage the suspend schedule based on a suspend schedule command. For example, the memory controller 100 may input a suspend schedule command, analyze a pattern of the suspend schedule command, and determine a suspend schedule based on the analysis result. For example, the memory controller 100 may be configured to identify a suspend pattern included in the suspend schedule command. The memory controller 100, according to an embodiment, may identify the suspend pattern by analyzing a pattern of the write command WRITE_CMD and the read command READ_CMD. For example, the memory controller 100 may be configured to analyze the pattern of the write command WRITE_CMD and the read command READ_CMD, determine one of a latency improvement mode (or a latency mode) or a data throughput improvement mode (or a throughput mode) based on the analysis result, and determine a suspend schedule for the memory device 200 based on one of the determined latency mode or throughput mode.

The latency mode, according to an embodiment, may refer to an operation of the memory system 10 that may focus on (e.g., prioritize) a read operation. For example, when the memory controller 100 determines that there are fewer read operations than write operations, the memory controller 100 may determine the suspend schedule based on the latency mode. Alternatively or additionally, when operating in the latency mode, the memory controller 100, according to an embodiment, may determine a suspend schedule that maintains the pattern of read operations. For example, the memory controller 100 may determine the suspend schedule to maintain the pattern of the read command READ_CMD exhibited in the latency mode.

The throughput mode, according to an embodiment, may refer to an operation of the memory system 10 that may focus on an overall throughput of read data operations and write data operations. For example, when the memory controller 100 determines that there are more read operations than write operations and the memory controller 100 is operating in the throughput mode, the memory controller 100, according to an embodiment, may group the read operations and determine a suspend schedule. For example, by grouping the read command READ_CMD in the throughput mode, the memory controller 100 may reduce the suspend operation, compared to a case in which the pattern of the read command READ_CMD is maintained. When the number of suspend operations is reduced, the memory system 10, according to an embodiment, may increase the amount of data that may be processed in the same unit time.

The memory device 200, according to an embodiment, may receive a write command WRITE_CMD and/or a read command READ_CMD from the memory controller 100 and perform a write operation and/or read operation based on the received write command WRITE_CMD and/or read command READ_CMD, respectively. The memory device 200, according to an embodiment, may include a volatile memory device and/or a nonvolatile memory device. For example, the memory device 200 may include volatile memory devices, such as, but not limited to, RAM, dynamic RAM (DRAM), static RAM (SRAM), fast page mode dynamic RAM (FPM DRAM), extended data output dynamic. RAM (EDO DRAM), synchronous dynamic RAM (SDRAM), double data rate synchronous dynamic RAM (DDR SDRAM), double data rate second type synchronous dynamic RAM (DDR2 SDRAM), double data rate third type synchronous dynamic RAM (DDR3 SDRAM), Rambus dynamic RAM (RDRAM), twin transistor RAM (TTRAM), thyristor RAM (T-RAM), zero capacitor (Z-RAM), Rambus inline memory module (RIMM), dual inline memory module (DIMM), single inline memory module (SIMM), video RAM (VRAM), cache memory (including various levels), flash memory, register memory, or the like.

In addition, the memory device 200 may include, but not be limited to, a floppy disk, a flexible disk, a hard disk, a solid-state storage (SSS), a solid-state card (SSC), solid-state module (SSM), enterprise flash drive, magnetic tape, or any other non-temporary magnetic medium, or the like. Nonvolatile computer-readable storage mediums may include, but not be limited to, a punch card, paper tape, optically marked sheet (or any other physical mediums with hole patterns or other optically recognizable marks), CD-ROM, compact disc-rewriteable (CD-RW), DVD, Blu-ray disc (BD), and other non-transitory optical medium. These nonvolatile computer-readable storage mediums may also include, but not be limited to, ROM, programmable PROM), erasable programmable read-only memory (EPROM), electrically erasable programmable read-only memory (EEPROM), and flash memory (e.g., NAND, NOR, or the like), multimedia memory card (MMC), secure digital (SD) memory, smart media card, CompactFlash (CF) card, memory stick, or the like. In addition, nonvolatile computer readable storage mediums may include, but not be limited to, CBRAM, PRAM, FeRAM, NVRAM, MRAM, RRAM, silicon-oxide-nitride-oxide-silicon memory (SONOS), floating junction gate RAM (FJG RAM), or the like.

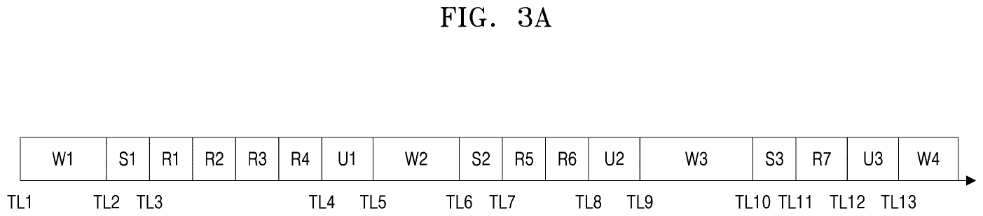

FIG. 2 is a block diagram of the memory controller 100, according to an embodiment.

Referring to FIG. 2, the memory controller 100, according to an embodiment, may include an input module 110, an analysis module 120, and a memory interface circuit 130.

The input module 110, according to an embodiment, may input (e.g., generate and/or provide) a Suspend Schedule CMD. For example, the input module 110 may input the Suspend Schedule CMD to the analysis module 120. The Suspend Schedule CMD, according to an embodiment, may be and/or may include a command that may determine the order and number of suspend operations. The suspend operation, according to an embodiment, may refer to an operation of stopping transmission of the write command WRITE_CMD and the read command READ_CMD before the write command WRITE_CMD stops and the read command READ_CMD starts. The suspend schedule, according to an embodiment, may refer to an operation of scheduling a suspend operation by determining the order of the write command WRITE_CMD and the read command READ_CMD.

The analysis module 120, according to an embodiment, may analyze a pattern of the Suspend Schedule CMD and determine a suspend schedule based on the analysis result. For example, the analysis module 120 may analyze the pattern of the write command WRITE_CMD and the read command READ_CMD included in the Suspend Schedule CMD and determine a suspend schedule. The analysis module 120, according to an embodiment, may transmit a determined suspend schedule to the memory interface circuit 130.

The analysis module 120, according to an embodiment, may be configured to analyze the pattern of the Suspend Schedule CMD at a preset period, determine one of the latency mode and the throughput mode based on the analysis result, and determine a suspend schedule for the memory device based on one of the determined latency mode or throughput mode. The preset period, according to an embodiment, may be a data processing unit previously input into the memory controller 100. For example, the memory controller 100 may analyze the pattern of the read command READ_CMD and the write command WRITE_CMD included in the Suspend Schedule CMD every 70 microseconds (μs). However, the present disclosure is not limited in this regard, and the memory controller 100 may analyze the pattern of the read command READ_CMD and the write command WRITE_CMD at various other preset periods. In an embodiment, the present period may be determined based on design constraints.

The analysis module 120, according to an embodiment, may be configured to identify the suspend pattern included in the Suspend Schedule CMD. The analysis module 120, according to an embodiment, may identify the suspend pattern by analyzing the pattern of the write command WRITE_CMD and the read command READ_CMD. For example, the analysis module 120 may be configured to analyze the pattern of the write command WRITE_CMD and the read command READ_CMD, determine one of the latency mode or the throughput mode based on the analysis result, and determine a suspend schedule for the memory device 200 based on one of the determined latency mode or throughput mode.

The analysis module 120, according to an embodiment, may be configured to change the suspend schedule in real time. For example, the analysis module 120 may determine the suspend schedule based on the latency mode in a first period and determine the suspend schedule based on the throughput mode in a second (e.g., subsequent) period. The analysis module 120, according to an embodiment, may analyze a pattern of the Suspend Schedule CMD in real time and change the suspend schedule (Suspend Schedule) in real time.

The analysis module 120, according to an embodiment, may be configured to determine a suspend latency based on a preset reference (and/or predetermined condition) when changing the suspend schedule. The suspend latency, according to an embodiment, may be and/or may include a time during which the suspend operation is performed. In addition, the analysis module 120, according to an embodiment, may be configured to determine a write resume time latency based on a preset reference when changing the suspend schedule. The write resume time latency, according to an embodiment, may be and/or may include a latency time that occurs at a time point of transition from the read command READ_CMD to the write command WRITE_CMD. The preset reference, according to an embodiment, may be determined by comparing the numbers of write commands WRITE_CMD and read commands READ_CMD. For example, when it is determined that the read command READ_CMD is greater than the write command WRITE_CMD as a result of analyzing the Suspend Schedule CMD, the analysis module 120 may determine the suspend schedule based on the throughput mode. As another example, when it is determined that the read command READ_CMD is less than the write command WRITE_CMD as the result of analyzing the Suspend Schedule CMD, the analysis module 120 may determine the suspend schedule (Suspend Schedule) based on the latency mode.

The latency mode, according to an embodiment, may refer to an operation of the memory controller 100 that may focus on (e.g., prioritize) a read operation. For example, when it is determined that there are fewer read operations than write operations, the analysis module 120 may determine a suspend schedule based on the latency mode. When operating in the latency mode, the memory controller 100, according to an embodiment, may determine the suspend schedule to maintain the pattern of read operations. For example, the analysis module 120 may determine the suspend schedule to maintain the pattern of the read command READ_CMD in the latency mode.

The throughput mode, according to an embodiment, may refer to an operation of the memory controller 100 that may focus on an overall throughput of read data operations and write data operations. For example, when it is determined that there are more read operations than write operations and the analysis module 120 operates in the throughput mode, the memory controller 100, according to an embodiment, may determine a suspend schedule by grouping read operations. For example, the memory controller 100 may reduce the suspend operation by grouping the read command READ_CMD in the throughput mode compared to a case in which the pattern of the read command READ_CMD is maintained. When the number of suspend operations is reduced, the memory controller 100, according to an embodiment, may increase the amount of data that may be processed in the same unit of time.

The memory interface circuit 130, according to an embodiment, may perform a read operation and/or a write operation on the memory device 200 based on the suspend schedule determined in the analysis module 120. For example, the memory interface circuit 130 may transmit the read command READ_CMD and the write command WRITE_CMD generated based on the suspend schedule to the memory device 200, and the memory device 200 may perform a read operation and/or a write operation based on the received read command READ_CMD and the write command WRITE_CMD.

The components of the memory controller 100 may, individually or collectively, be implemented with one or more ASICs and/or FPGAs adapted to perform some or all of the applicable functions in hardware. Each of the noted modules may provide for performing one or more functions related to operation of the memory controller 100. Each of the noted components may provide for performing one or more functions related to operation of the memory system 10.

The number and arrangement of components of the memory controller 100 shown in FIG. 2 are provided as an example. In practice, there may be additional components, fewer components, different components, or differently arranged components than those shown in FIG. 2. Furthermore, two or more components shown in FIG. 2 may be implemented within a single component, or a single component shown in FIG. 2 may be implemented as multiple, distributed components. For example, the input module 110 and the analysis module 120 may be incorporated into the memory interface circuit 130. Alternatively or additionally, a set of (one or more) components shown in FIG. 2 may be integrated with each other, and/or may be implemented as an integrated circuit, as software, and/or a combination of circuits and software.

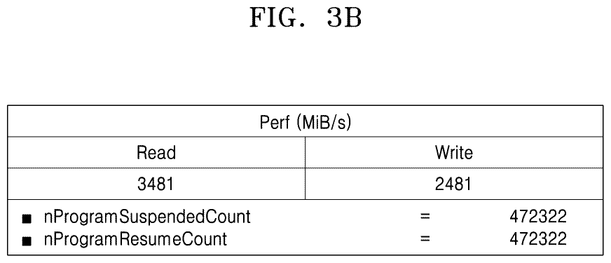

FIG. 3A illustrates a suspend schedule command input by the memory controller 100 in the latency mode, according to an embodiment.

Referring to FIGS. 2 and 3A together, the memory controller 100, according to an embodiment, may determine a suspend schedule to maintain the pattern of the read command READ_CMD in the latency mode.

According to an embodiment, a suspend schedule command (e.g., Suspend Schedule CMD) may include a first write command W1 at a latency mode first time point TL1, a first suspend command S1 at a latency mode second time point TL2, and a first read command R1 at a latency mode third time point TL3. The Suspend Schedule CMD, according to an embodiment, may include a first read command R1, a second read command R2, a third read command R3, and a fourth read command R4 from the latency mode third time point TL3 to a latency mode fourth time point TL4. The Suspend Schedule CMD, according to an embodiment, may include a first write resume command U1 at a latency mode fourth time point TL4 and include a second write operation command W2 at a latency mode fifth time point TL5. A period from the latency mode fourth time point TL4 to the latency mode fifth time point TL5, according to an embodiment, may be a write resume time point latency period.

Since the Suspend Schedule CMD, according to an embodiment, may be configured to maintain the pattern of the read command READ_CMD and the write command WRITE_CMD in the latency mode, the Suspend Schedule CMD may be configured to include a second suspend command S2 at a latency mode sixth time point TL6 and include a fifth read command R5 from a latency mode seventh time point TL7. The Suspend Schedule CMD, according to an embodiment, may be configured to include a read command again from the seventh latency mode time point TL7 to an eighth latency mode time point TL8. For example, the Suspend Schedule CMD may include a fifth read command R5 and a sixth read command R6 from the latency mode seventh time point TL7 to the latency mode eighth time point TL8.

The Suspend Schedule CMD, according to an embodiment, may be configured to include a second write resume command U2 at the latency mode eighth time point TL8, include a third write command at a latency mode ninth time point TL9, and include a third suspend command S3 at a latency mode tenth time point TL10. The Suspend Schedule CMD, according to an embodiment, may be configured to include the third suspend command S3 from the latency mode tenth time point TL10 to a latency mode eleventh time point TL11 and include a seventh read command R7 again from the latency mode eleventh time point TL11 to include a read command again.

The Suspend Schedule CMD, according to an embodiment, may be configured to include a write resume command again at the latency mode twelfth time point TL12. For example, the Suspend Schedule CMD may be configured to include a third write resume command U3 at the latency mode twelfth time point TL12 and include a fourth write command W4 from a latency mode thirteenth time point TL13.

Although FIG. 3A depicts an embodiment in which the pattern of the Suspend Schedule CMD is not changed, the present disclosure is not limited in this regard, and the number and pattern of the write command WRITE_CMD and read command READ_CMD may be changed.

FIG. 3B illustrates data throughput when the memory system 10 operates in the latency mode, according to an embodiment.

Referring to FIGS. 2, 3A, and 3B together, when the Suspend Schedule CMD, according to an embodiment, is configured based on the latency mode, the memory controller 100 may process a read command at up to 3,481 microbits per second (MiB/s) and process a write command at up to 2,481 MiB/s. As shown in FIG. 3B, the number of suspend operations (e.g., nProgramSuspendedCount) may be 472,322 and the number of write resume operations (e.g., nProgramResumeCount) may be 472,322.

The embodiments illustrated on FIGS. 3A and 3B are only examples of embodiments of the Suspend Schedule CMD of the present disclosure, and the memory system of the present disclosure may be configured as an embodiment having different result values of different patterns.

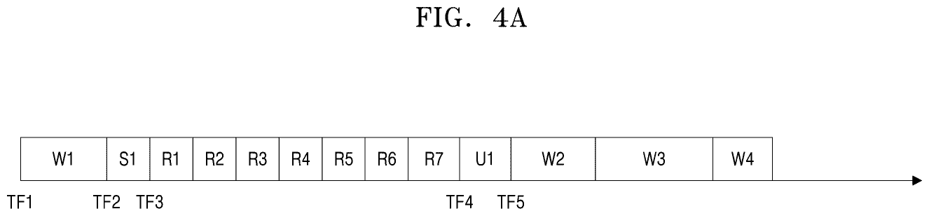

FIG. 4A illustrates a suspend scheduling command input by a host in a throughput mode, according to an embodiment.

Referring to FIGS. 2 and 4A, the Suspend Schedule CMD, according to an embodiment, may change the pattern of the read command READ_CMD and the write command WRITE_CMD in the throughput mode. For example, compared to the Suspend Schedule CMD disclosed in FIG. 3A, in the throughput mode, the memory controller 100 may group each of the read command READ_CMD and write command WRITE_CMD and reduce the number of suspends.

The suspend schedule CMD, according to an embodiment, may be configured to include a first write command W1 at a throughput mode first time point TF1 and include a first suspend command S1 at a second throughput mode second time point TF2. The Suspend Schedule CMD, according to an embodiment, may be configured to include a first read command R1 at a throughput mode third time point TF3.

The Suspend Schedule CMD, according to an embodiment, may be configured by grouping read commands compared to the embodiment of FIG. 3A. For example, the Suspend Schedule CMD may be configured to include a first read command R1, a second read command R2, a third read command R3, a fourth read command R4, a fifth read command R5, a sixth read command R6, and a seventh read command R7 from the throughput mode third time point TF3 to a throughput mode fourth time point TF4. That is, in the embodiment of FIG. 4A, compared to the embodiment of FIG. 3A, the Suspend Schedule CMD may be configured by grouping the first read command R1, the second read command R2, the third read command R3, the fourth read command R4, the fifth read command R5, the sixth read command R6, and the seventh read command R7.

In the throughput mode, according to an embodiment, the Suspend Schedule CMD may be configured to include a first write resume command U1 at a throughput mode fourth time point TF4 and a second write command W2 at a throughput mode fifth time point TF5. The Suspend Schedule CMD, according to an embodiment, may be configured to transfer a write command by grouping a second write command W2, a third write command W3, and a fourth write command W4 from the throughput mode fifth time point TF5.

Although FIG. 4A depicts an example in which the pattern of the Suspend Schedule CMD is changed, the present disclosure is not limited in this regard and the number and pattern of the write command WRITE_CMD and read command READ_CMD may be changed from those depicted in FIG. 4A without departing from the scope of the present disclosure.

FIG. 4B illustrates data throughput when the memory system 10, according to an embodiment, operates in the throughput mode.

Referring to FIGS. 2, 4A, and 4B together, when the Suspend Schedule CMD, according to an embodiment, is configured based on the throughput mode, the memory controller 100 may process a read command at up to 3,748 MiB/s and process a write command at up to 2578 MiB/s. As shown in FIG. 4B, the number of suspend operations (e.g., nProgramSuspendedCount) may be 103,350, and the number of write resume operations (e.g., nProgramResumeCount) may be 103,350.

That is, when operating in the throughput mode, the memory controller 100, according to an embodiment, may process a greater number of read commands READ_CMD and write commands WRITE_CMD per unit time and perform fewer suspend operations, compared to operating in the latency mode. In an embodiment, the memory controller 100 may increase the amount of data that may be processed per unit time by reducing the number of suspend operations.

The embodiments illustrated on FIGS. 4A and 4B are example embodiments of the Suspend Schedule CMD of the present disclosure, and in other embodiments, the memory system may be configured to have different result values of different patterns.

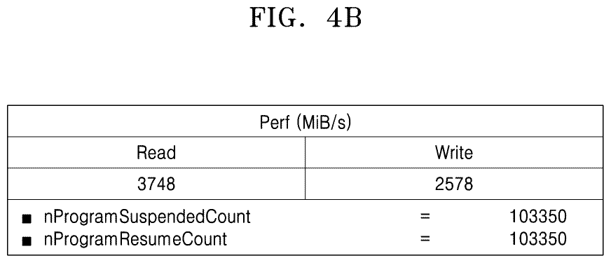

FIG. 5 illustrates a scheduling part of a suspend scheduling command, according to an embodiment.

Referring to FIG. 5, the Suspend Schedule CMD, according to an embodiment, may include a write variable part tProg and a scheduling part Scheduling Part, may include a suspend period Suspend_T after the write variable part tProg, and may include a write resume period Resume_T after the scheduling part Scheduling Part.

The memory controller 100, according to an embodiment, may adjust the suspend period Suspend_T and the write resume period Resume_T by adjusting the number of read commands included in the scheduling part Scheduling Part. For example, the memory controller 100 may adjust the suspend period Suspend_T by adjusting the number of read commands included in the scheduling part Scheduling Part and determine a suspend latency. As another example, the memory controller 100 may adjust the write resume period Resume_T by adjusting the number of read commands included in the scheduling part Scheduling Part and determine a write resume time point latency.

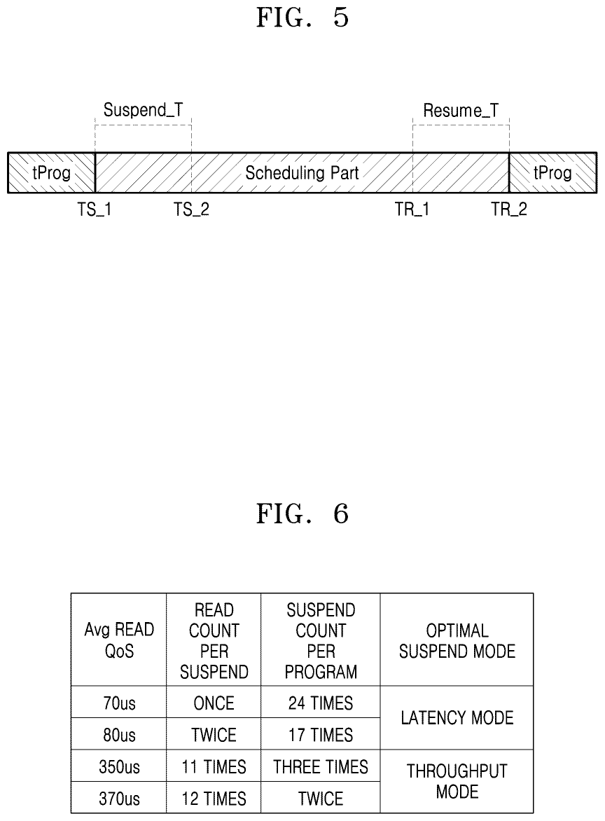

FIG. 6 illustrates analysis of a scheduling pattern at a predetermined period, according to an embodiment.

Referring to FIGS. 2 and 6, the memory controller 100, according to an embodiment, may determine an optimal suspend mode based on the number of read commands or the number of suspend operations that exist in a predetermined period.

When the number of suspend operations is greater than the number of read operations, the memory controller 100, according to an embodiment, may operate in the latency mode.

For example, when an average read command data processing period (e.g., average (Avg) Read quality-of-service (QoS)) is set to 70 μs, the memory controller 100 may operate in the latency mode and configure the Suspend Schedule CMD such that one (1) read command is included per suspend operation and the suspend operation is performed 24 times per write operation. As another example, when the average read command data processing period (e.g., Avg Read QoS) is set to 80 μs, the memory controller 100 may operate in the latency mode and configure the Suspend Schedule CMD such that two (2) read commands are included per suspend operation and the suspend operation is performed 17 times per write operation.

When the number of suspend operations is less than the number of read operations, the memory controller 100, according to an embodiment, may operate in the throughput mode.

For example, when the average read command data processing period (e.g., Avg Read QoS) is set to 350 μs, the memory controller 100 may operate in the throughput mode and configure the Suspend Schedule CMD such that 11 read commands are included per suspend operation and the suspend operation is performed three (3) times per write operation. As another example, when the average read command data processing period (e.g., Avg Read QoS) is set to 370 μs, the memory controller 100 may operate in the latency mode and configure the Suspend Schedule CMD such that 12 read commands are included per suspend operation and the suspend operation is performed twice (e.g., 2 times) per write operation.

Although FIG. 6 illustrates examples of the number of suspends and reads processed by the memory controller 100, the present disclosure is not limited in this regard, and the Suspend Schedule CMD may be configured according to other references.

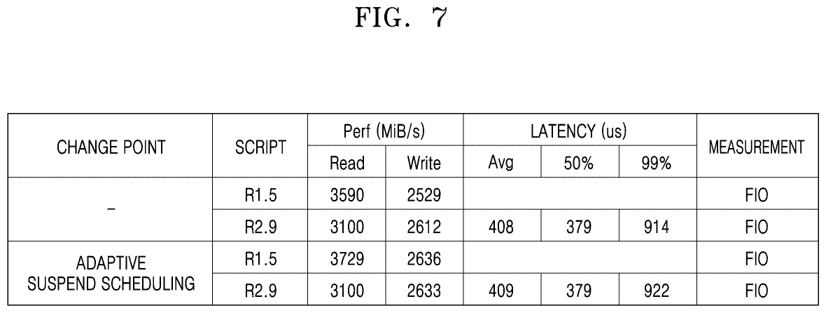

FIG. 7 illustrates data throughput in the latency mode and the throughput mode, according to an embodiment.

Referring to FIGS. 2 and 7, a change point, according to an embodiment, may be and/or may include an item indicating whether a suspend scheduling change operation is performed and a script may refer to an item indicating an operation mode of the memory controller 100. For example, script R1.5 may indicate the throughput mode, and script R2.9 may indicate the latency mode. Data throughput (e.g., Perf), according to an embodiment, may be described as the number of reads or writes processed per unit time (e.g., MiB/s), and the unit of latency may be microseconds (μs). Data throughput measurement, according to an embodiment, may be performed in a flexible input/output test mode (FIOL).

Referring to FIG. 7, when the suspend scheduling change operation (Adaptive Suspend Scheduling) is not performed, in the throughput mode (e.g., script R1.5), the memory controller 100, according to an embodiment, may process read commands at 3,590 MiB/s and process write commands at 2,529 MiB/s. When the Adaptive Suspend Scheduling is not performed, in the latency mode (e.g., script R2.9), the memory controller 100, according to an embodiment, may process read commands at 3,100 MiB/s and write commands at 2,612 MiB/s. When the Adaptive Suspend Scheduling is not performed, in the latency mode, the memory controller 100, according to an embodiment, may have a maximum latency of 914 μs (at a maximum 99% confidence coefficient), a minimum latency of 379 μs (at a confidence coefficient of 50%), and an average latency of 408 μs.

When the Adaptive Suspend Scheduling is performed, in the throughput mode (e.g., script R1.5), the memory controller 100, according to an embodiment, may process read commands at 3,729 MiB/s and process write commands at 2,636 MiB/s. When the Adaptive Suspend Scheduling is performed, in the latency mode (e.g., R2.9), the memory controller 100, according to an embodiment, may process read commands at 3,100 MiB/s and may process write commands of 2,633 MiB/s. When the Adaptive Suspend Scheduling is performed, in the latency mode, the memory controller 100, according to an embodiment, may have a maximum latency of 922 μs (at a maximum 99% confidence coefficient), a minimum latency of 379 μs (at a confidence coefficient of 50%), and an average latency of 409 μs.

As shown in FIG. 7, data throughput of the memory controller 100 may be improved when the Adaptive Suspend Scheduling is performed, while a command latency time does not change significantly, compared to the case in which the Adaptive Suspend Scheduling is not performed. For example, when the Adaptive Suspend Scheduling is performed in the throughput mode, the memory controller 100 may process read commands at 3,729 MiB/s and process write commands at 2,636 MiB/s, while the Adaptive Suspend Scheduling is not performed, in the throughput mode (e.g., script R1.5), the memory controller 100, according to an embodiment, may process read commands at 3,590 MiB/s and may process write commands at 2,529 MiB/s. That is, aspects of the present disclosure provide for potentially increasing data throughput per unit time without increasing command latency.

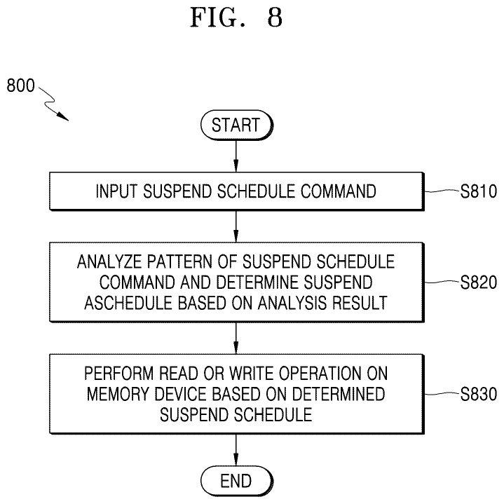

FIG. 8 is a flowchart of an operating method 800 of the memory system 10, according to an embodiment.

Referring to FIGS. 1, 2, and 8, the memory system 10, according to an embodiment, may input the Suspend Schedule CMD (operation S810).

The memory system 10, according to an embodiment, may manage a suspend schedule based on the Suspend Schedule CMD. The suspend operation, according to an embodiment, may be and/or may include an operation of stopping transmission of the write command WRITE_CMD and the read command READ_CMD before the read command READ_CMD starts after the write command WRITE_CMD stops. The suspend schedule, according to an embodiment, may be and/or may include an operation of scheduling a suspend operation by determining the order of the previous write command WRITE_CMD and the read command READ_CMD.

When the Suspend Schedule CMD is input, the memory system 10, according to an embodiment, may analyze the pattern of the Suspend Schedule CMD and determine the suspend schedule based on the analysis result (operation S820).

The memory system 10, according to an embodiment, may manage the suspend schedule based on the Suspend Schedule CMD. For example, the memory system 10 may input the Suspend Schedule CMD, analyze the pattern of the Suspend Schedule CMD, and determine the suspend schedule based on the analysis result. As another example, the memory system 10 may be configured to identify the suspend pattern included in the Suspend Schedule CMD. The memory system 10, according to an embodiment, may recognize the suspend pattern by analyzing the pattern of the write command WRITE_CMD and the read command READ_CMD. For example, the memory system 10 may be configured to analyze the pattern of the write command WRITE_CMD and the read command READ_CMD, determine one of a latency improvement mode (or a latency mode) or a data throughput improvement mode (or a throughput mode) based on the analysis result, and determine a suspend schedule for the memory device 200 based on one of the determined latency mode or throughput mode.

The latency mode, according to an embodiment, may be and/or may include an operation of the memory system 10 that may focus on read operations. For example, when the memory system 10 determines that there are fewer read operations than write operations, the memory system 10 may determine the suspend schedule based on the latency mode. When operating in the latency mode, the memory system 10, according to an embodiment, may determine the suspend schedule so that the pattern of read operations is maintained. For example, the memory system 10 may determine the suspend schedule to maintain the pattern of the read command READ_CMD in the latency mode.

The throughput mode, according to an embodiment, may be and/or may include an operation of the memory system 10 that may focus on the overall throughput of read data operations and write data operations. For example, when the memory controller 100 determines that there are more read operations than write operations and the memory system 10 operates in the throughput mode, the memory system 10, according to an embodiment, may group the read operations and determine a suspend schedule. For example, by grouping the read command READ_CMD in the throughput mode, the memory system 10 may reduce the suspend operation, compared to a case in which the pattern of the read command READ_CMD is maintained. When the number of suspend operations is reduced, the memory system 10, according to an embodiment, may increase the amount of data that may be processed for the same unit time.

When the suspend schedule is determined, the memory system 10, according to an embodiment, may perform a read or write operation on the memory device 200 based on the determined suspend schedule (operation S830).

The memory device 200, according to an embodiment, may receive the write command WRITE_CMD or the read command READ_CMD generated based on the Suspend Schedule CMD from the memory controller 100, and perform a write operation or read operation based on the received write command WRITE_CMD or the read command READ_CMD.

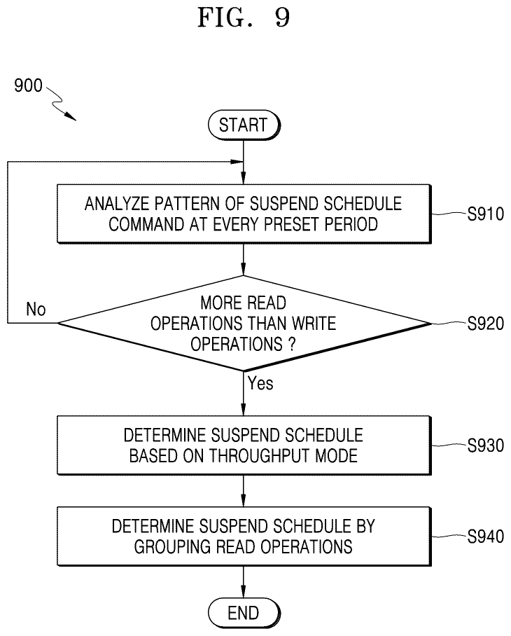

FIG. 9 is a flowchart of a method 900 of determining a suspend schedule based on a throughput mode in an operating method of the memory system 10, according to an embodiment.

Referring to FIGS. 1, 2, and 9, the memory system 10, according to an embodiment, may analyze the pattern of the Suspend Schedule CMD at every preset period (operation S910).

The memory system 10, according to an embodiment, may analyze the pattern of the Suspend Schedule CMD at every preset period, determine one of the latency mode and the throughput mode based on the analysis result, and determine the suspend schedule for the memory device based on one of the determined latency mode or throughput mode. The preset period, according to an embodiment, may be and/or may include a data processing unit previously input to the memory system 10. For example, the memory system 10 may analyze the pattern of the read command READ_CMD and the write command WRITE_CMD included in the Suspend Schedule CMD every 70 μs. However, the present disclosure is not limited in this regard, and various preset periods may be determined without departing from the scope of the present disclosure.

The memory system 10, according to an embodiment, may determine whether there are more read operations than write operations (operation S920).

The memory system 10, according to an embodiment, may be configured to identify a suspend pattern included in the Suspend Schedule CMD. The memory system 10, according to an embodiment, may identify the suspend pattern by analyzing the pattern of the write command WRITE_CMD and the read command READ_CMD. For example, the memory system 10 may analyze the pattern of the write command WRITE_CMD and the read command READ_CMD, determine either the latency mode or the throughput mode based on the analysis result, and determine a suspend schedule based on one of the determined latency mode or throughput mode.

The memory system 10, according to an embodiment, may be configured to determine a suspend latency based on a preset reference when changing the suspend schedule. The suspend latency, according to an embodiment, may be and/or may include time for which a suspend operation is performed. In addition, the memory system 10, according to an embodiment, may be configured to determine a write resume time latency based on a preset reference when changing the suspend schedule. The write resume time latency, according to an embodiment, may be a latency time that occurs at a time point of transitioning from the read command READ_CMD to the write command WRITE_CMD. A preset reference, according to an embodiment, may be determined by comparing the numbers of write commands WRITE_CMD and read commands READ_CMD.

When it is determined that there are more read operations than write operations (Yes in operation S920), the memory system 10 may determine the suspend schedule based on the throughput mode (S930). For example, when it is determined that the read command READ_CMD is greater than the write command WRITE_CMD as a result of analyzing the Suspend Schedule CMD, the memory system 10 may determine the suspend schedule based on the throughput mode.

Alternatively, when it is determined that there are not more read operations than write operations (No in operation S920), the memory system 10, according to an embodiment, may analyze the pattern of the Suspend Schedule CMD again. That is, the method 900 may return to operation S910.

The memory system 10, according to an embodiment, may determine the suspend schedule by grouping read operations (operation S940). The throughput mode, according to an embodiment, may be and/or may include an operation of the memory system 10 that focuses on overall throughput of read data and write data. For example, when it is determined that there are more read operations than write operations and the memory system 10 operates in the throughput mode, the memory system 10, according to an embodiment, may determine the suspend schedule by grouping the read operations. For example, the memory system 10 may reduce the suspend operation by grouping the read command READ_CMD in the throughput mode, compared to a case in which the pattern of the read command READ_CMD is maintained. When the number of suspend operations is reduced, the memory system 10, according to an embodiment, may increase the amount of data that may be processed in the same unit time.

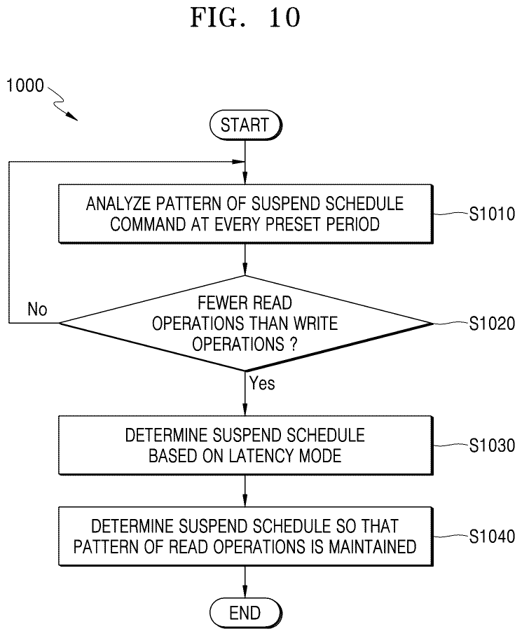

FIG. 10 is a flowchart of a method 1000 of determining a suspend schedule based on a latency mode in an operating method of the memory system 10, according to an embodiment.

Referring to FIGS. 1, 2, and 10, the memory system 10, according to an embodiment, may analyze the pattern of the Suspend Schedule CMD at every preset period (operation S1010).

The memory system 10, according to an embodiment, may be configured to analyze the pattern of the Suspend Schedule CMD at every preset period, determine one of the latency mode and the throughput mode based on the analysis result, and determine a suspend schedule for the memory device based on one of the determined latency mode or throughput mode. The preset period, according to an embodiment, may be and/or may include a data processing unit previously input to the memory system 10. For example, the memory system 10 may analyze the pattern of the read command READ_CMD and the write command WRITE_CMD included in the Suspend Schedule CMD every 70 μs. However, the present disclosure is not limited in this regard, and various preset periods may be determined without departing from the scope of the present disclosure.

The memory system 10, according to an embodiment, may determine whether there are fewer read operations than write operations (operation S1020).

When it is determined that there are fewer read operations than write operations (Yes in operation S1020), the memory system 10, according to an embodiment, may determine the suspend schedule based on the latency mode (operation S1030). For example, when it is determined that the read commands READ_CMD are less than the write commands WRITE_CMD as a result of analyzing the Suspend Schedule CMD, the memory system 10 may determine the suspend schedule based on the latency mode.

Alternatively, when it is determined that there are more read operations than write operations (No in operation S1020), the memory system 10, according to an embodiment, may analyze the pattern of the Suspend Schedule CMD again. That is, the method 1000 may return to operation S1010.

When the suspend schedule is determined based on the latency mode, the memory system 10, according to an embodiment, may determine the suspend schedule so that the pattern of read operations is maintained (operation S1040).

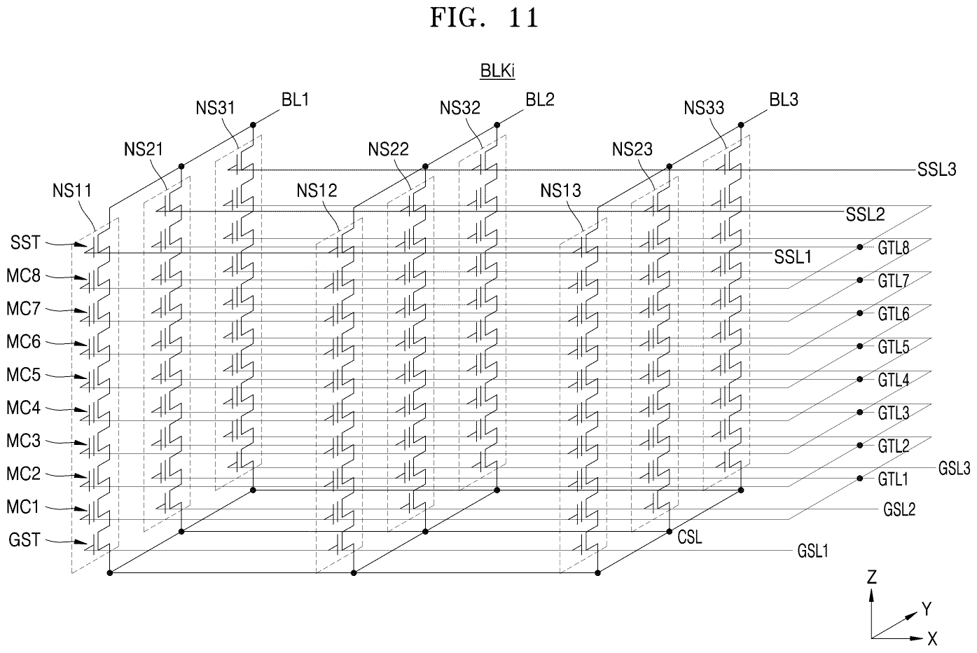

FIGS. 11 to 13 are diagrams illustrating a three-dimensional (3D) vertical NAND (V-NAND) structure that may be applied to the memory device 200 of FIG. 1, according to an embodiment.

Referring to FIG. 11, the memory device 200 may include a plurality of memory blocks. FIGS. 11 to 13 illustrate a structure of one memory block BLKi from among the plurality of memory blocks.

Referring to FIG. 11, the memory block BLKi may include a plurality of memory NAND strings (e.g., a first memory NAND string NS11, a second memory NAND string NS12, a third memory NAND string NS13, a fourth memory NAND string NS21, a fifth memory NAND string NS22, a sixth memory NAND string NS23, a seventh memory NAND string NS31, an eighth memory NAND string NS32, and a ninth memory NAND string NS33) connected between a plurality of bit lines (e.g., a first bit line BL1, a second bit line BL2, and a third bit line BL3) and a common source line CSL. Each of the plurality of memory NAND strings NS11 to NS33 may include a string select transistor SST, a plurality of memory cells (e.g., a first memory cell MC1, a second memory cell MC2, a third memory cell MC3, a fourth memory cell MC4, a fifth memory cell MC5, a sixth memory cell MC6, a seventh memory cell MC7, and an eighth memory cell MC8), and a ground select transistor GST. For the sake of brevity of the drawing, FIG. 10 shows that each of the plurality of memory NAND strings NS11 to NS33 includes eight (8) memory cells MC1 to MC8, however, the present disclosure is not limited in this regard.

Each string select transistor SST may be connected to the corresponding string select line (e.g., a first string select line SSL1, a second string select line SSL2, or a third string select line SSL3). The plurality of memory cells MC1 to MC8 may be connected to corresponding gate lines (e.g., a first gate line GTL1, a second gate line GTL2, a third gate line GTL3, a fourth gate line GTL4, a fifth gate line GTL5, a sixth gate line GTL6, a seventh gate line GTL7, and an eighth gate line GTL8) respectively. The first to eighth gate lines GTL1 to GTL8 may correspond to word lines, and some of the first to eighth gate lines GTL1 to GTL8 may correspond to dummy word lines. Each ground select transistor GST may be connected to the corresponding ground select line (e.g., a first ground select line GSL1, a second ground select line GSL2, or a third ground select line GSL3). Each string select transistor SST may be connected to the corresponding bit line from among the plurality of bit lines BL1 to BL3, and the ground select transistor GST may be connected to the common source line CSL.

Gate lines (e.g., the first gate line GTL1) at the same height may be connected in common, and the ground selection lines GSL1 to GSL3 and the string selection lines SSL1 to SSL3 may be separated from each other. Although FIG. 11 illustrates the memory block BLKi as being connected to eight (8) gate lines GTL1 to GTL8 and three (3) bit lines BL1 to BL3, the present disclosure is not limited thereto.

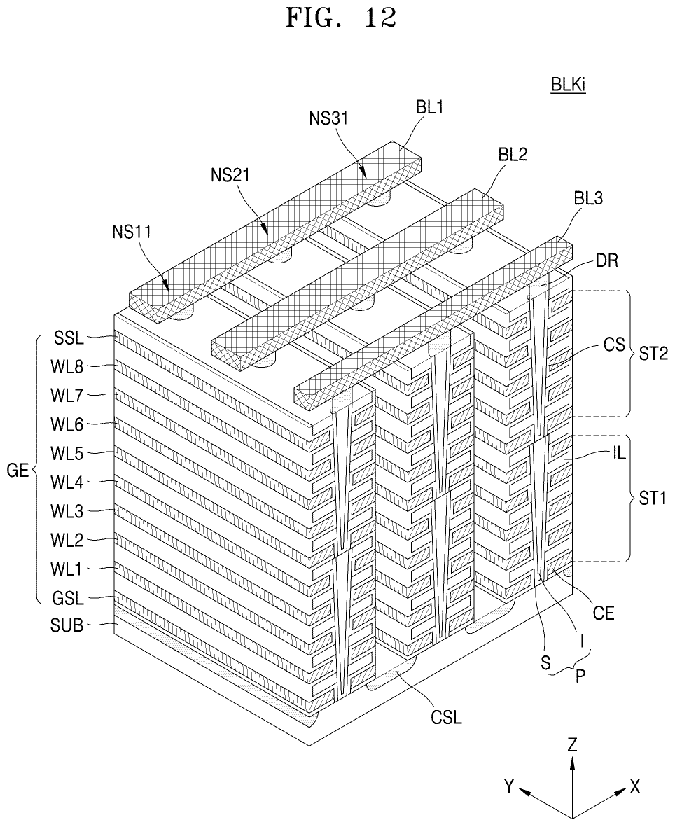

Referring further to FIG. 12, the memory block BLKi may be formed in a vertical direction with respect to a substrate SUB. Memory cells constituting the memory NAND strings NS11 to NS33 may be formed to be stacked on a plurality of semiconductor layers.

On the substrate SUB, the common source line CSL extending in a first direction (a Y direction) is provided. In a region of the substrate SUB between two adjacent common source lines CSL, a plurality of insulating films IL extending in the first direction (the Y direction) are sequentially provided in a third direction (a Z direction), and the insulating films IL may be apart from each other by a certain distance in the third direction (the Z direction). In the region of the substrate SUB between two adjacent common source lines CSL, a plurality of pillars P may be sequentially arranged in the first direction (the Y direction) and pass through the insulating films IL in the third direction (the Z direction). The pillars P may pass through the insulating films IL and contact the substrate SUB. A surface layer S of each pillar P may include a silicon (Si) material doped with a first conductivity type and may function as a channel region.

An internal layer I of each pillar P may include an insulating material, such as, but not limited to, silicon oxide (SiO₂), or an air gap. In the region between two adjacent common source lines CSL, a charge storage layer CS may be provided along exposed surfaces of the insulating films IL, pillars P, and substrate SUB. The charge storage layer CS may include a gate insulating layer (also referred to as a tunneling insulating layer), a charge trap layer, and a blocking insulating layer. In addition, in the region between two adjacent common source lines CSL, gate electrodes GE, such as the select lines GSL and SSL and word lines WL1 to WL8, may be provided on the exposed surface of the charge storage layer CS. Drains or drain contacts DR may be provided on the plurality of pillars P, respectively. The plurality of bit lines BL1 to BL3 extending in a second direction (an X direction) and being apart from each other by a certain distance in the first direction (the Y direction) may be provided on the drain contacts DR.

As shown in FIG. 12, each of the plurality of memory NAND strings NS11 to NS33 may be implemented in a structure in which a first memory stack ST1 and a second memory stack ST2 are stacked. The first memory stack ST1 may be connected to the common source line CSL, the second memory stack ST2 may be connected to the plurality of bit lines BL1 to BL3, and the first memory stack ST1 and the second memory stack ST2 may be stacked to share channel holes with each other.

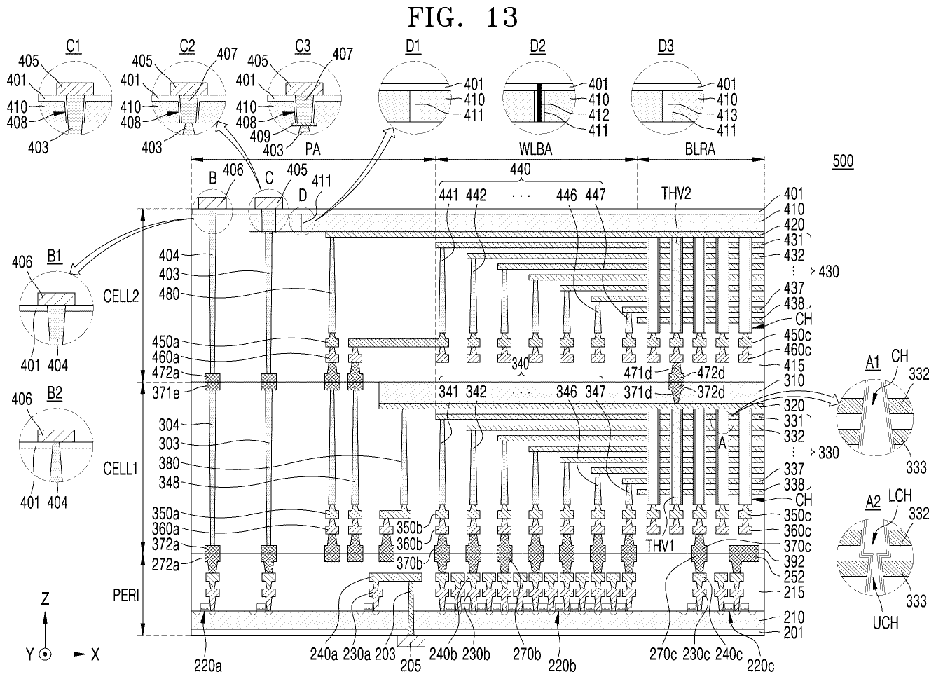

FIG. 13 is a cross-sectional view illustrating a memory device 500 having a bonding V-NAND (B-VNAND) structure, according to an embodiment.

FIG. 13 is a diagram illustrating the memory device 500, according to an embodiment.

Referring to FIG. 13, the memory device 500 may have a chip-to-chip (C2C) structure. As used herein, the C2C structure may refer to manufacturing at least one upper chip including a cell region CELL, manufacturing a lower chip including a peripheral circuit region PERI, and connecting the at least one upper chip to the lower chip by a bonding method. Alternatively or additionally, the bonding method may refer to a method of electrically and/or physically connecting a bonding metal pattern formed on an uppermost metal layer of the upper chip to a bonding metal pattern formed on an uppermost metal layer of the lower chip. For example, when the bonding metal patterns include copper (Cu), the bonding method may referred to as a Cu—Cu bonding method. As another example, the bonding metal patterns may include metals, such as, but not limited to, aluminum (Al) or tungsten (W). However, the present disclosure is not limited in this regard.

The memory device 500 may include at least one upper chip including a cell region. For example, as shown in FIG. 13, the memory device 500 may be implemented to include two (2) upper chips. However, the number of upper chips may not be limited in this regard. In a case in which the memory device 500 is implemented to include two (2) upper chips, the memory device 500 may be manufactured by manufacturing a first upper chip including a first cell region CELL1, a second upper chip including a second cell region CELL2, and a lower chip including a peripheral circuit region separately, and connecting the first upper chip, the second upper chip, and the lower chip to each other through the bonding method. The first upper chip may be reversed to be connected to the lower chip through the bonding method, and the second upper chip may also be reversed to be connected to the first upper chip through the bonding method. As used herein, upper and lower sides of the first and second upper chips may be referred to based on a state before the first and second upper chips are reversed. That is, in FIG. 13, the upper side of the lower chip may refer to an upper side defined based on a +Z-axis direction, and the upper side of each of the first and second upper chips may refer to an upper side defined based on a −Z-axis direction. However, the present disclosure is not limited in this regard. For example, in an embodiment, only one of the first upper chip and the second upper chip may be reversed to be connected through the bonding method.

Each of the peripheral circuit region PERI and the first and second cell regions CELL1 and CELL2 of the memory device 500 may include an external pad bonding region PA, a word line bonding region WLBA, and a bit line bonding region BLBA.

The peripheral circuit region PERI may include a first substrate 210 and a plurality of circuit elements (e.g., a first circuit element 220a, a second circuit element 220b, and a third circuit element 220c) formed on the first substrate 210. An interlayer insulating layer 215 including one or more insulating layers may be provided on the plurality of circuit elements 220a to 220c, and a plurality of metal interconnections connecting the plurality of circuit elements 220a to 220c may be provided within the interlayer insulating layer 215. For example, the plurality of metal interconnections may include first metal interconnections (e.g., a first metal interconnection 230a, a second metal interconnection 230b, and a third metal interconnection 230c) respectively connected to the plurality of circuit elements 220a to 220c and second metal interconnections (e.g., a fourth metal interconnection 240a, a fifth metal interconnection 240b, and a sixth metal interconnection 240c) formed on the first metal interconnections 230a to 230c. The plurality of metal interconnections may include at least one of various conductive materials. For example, the first metal interconnections 230a to 230c may include a material having a relatively high electrical resistivity such as, but not limited to, tungsten (W), and the second metal interconnections 240a to 240c may include a material having a relatively low electrical resistivity, such as, but not limited to, copper (Cu).

Although FIG. 13 illustrates three (3) first metal interconnections 230a 230c and three (3) second metal interconnections 240a to 240c, the present disclosure is not limited thereto. For example, in an embodiment, at least one additional metal interconnection may be further formed on the second metal interconnections 240a to 240c. In such an embodiment, the second metal interconnections 240a to 240c may include aluminum (Al). In addition, at least some of the additional metal interconnections formed on the second metal interconnections 240a to 240c may include copper (Cu), or the like, having a lower electrical resistivity than aluminum (Al) of the second metal interconnections 240a to 240c.

The interlayer insulating layer 215 may be disposed on the first substrate 210 and may include an insulating material, such as, but not limited to, silicon oxide (SiO₂) or silicon nitride (Si₃N₄).

The first and second cell regions CELL1 and CELL2 may each include at least one memory block. The first cell region CELL1 may include a second substrate 310 and a common source line 320. On the second substrate 310, a plurality of word lines 330 (e.g., a first word line 331, a second word line 332, to a seventh word line 337, and an eighth word line 338) may be stacked in a direction (the Z-axis direction) perpendicular to an upper surface of the second substrate 310. String select lines and ground select lines may be disposed above and below the plurality of word lines 330, and the plurality of word lines 330 may be located between the string select lines and the ground select line. Similarly, the second cell region CELL2 may include a third substrate 410 and a common source line 420, and a plurality of word lines 430 (e.g., a first word line 431, a second word line 432, to a seventh word line 437, and an eighth word line 438) may be stacked in a direction (the Z-axis direction) perpendicular to an upper surface of the third substrate 410. The second substrate 310 and the third substrate 410 may include various materials and may include, for example, a silicon (Si) substrate, a silicon-germanium (Si—Ge) substrate, a germanium (Ge) substrate, or a substrate having a single crystal epitaxial layer grown on a monocrystalline silicon substrate. A plurality of channel structures CH may be formed in each of the first and second cell regions CELL1 and CELL2.

In an embodiment, as shown in region A1, the channel structure CH may be provided in the bit line bonding region BLBA and may extend in a direction perpendicular to the upper surface of the second substrate 310 to pass through the plurality of word lines 330, the string select lines, and the ground select lines. The channel structure CH may include a data storage layer, a channel layer, and a buried insulating layer. The channel layer may be electrically connected to the first metal interconnection 350c and the second metal interconnection 360c in the bit line bonding region BLBA. For example, the second metal interconnection 360c may be a bit line and may be connected to the channel structure CH through the first metal interconnection 350c. The second metal interconnection 360c may extend in the first direction (the Y-axis direction) parallel to the upper surface of the second substrate 310.

In an embodiment, as shown in region A2, the channel structure CH may include a lower channel LCH and an upper channel UCH connected to each other. For example, the channel structure CH may be formed through a process for the lower channel LCH and a process for the upper channel UCH. The lower channel LCH may extend in a direction perpendicular to the upper surface of the second substrate 310 and pass through the common source line 320 and lower word lines of the plurality of word lines 330 (e.g., the first word line 331 and the second word line 332). The lower channel LCH may include a data storage layer, a channel layer, and a buried insulating layer and may be connected to the upper channel UCH. The upper channel UCH may pass through upper word lines of the plurality of word lines 330 (e.g., the third word line 333 to the eighth word line 338). The upper channel UCH may include a data storage layer, a channel layer, and a buried insulating layer, and the channel layer of the upper channel UCH may be electrically connected to the first metal interconnection 350c and the second metal interconnection 360c. As the length of the channel increases, it may be difficult to form a channel having a constant width due to process reasons. The memory device 500, according to an embodiment, may have a channel having improved width uniformity through the lower channel LCH and the upper channel UCH formed through a sequential process.

As shown in region A2, when the channel structure CH is formed to include the lower channel LCH and the upper channel UCH, the word line 330 located near a boundary of the lower channel LCH and the upper channel UCH may be a dummy word line. For example, the word lines (e.g., the second word line 332 and the third word line 333) that form the boundary between the lower channel LCH and the upper channel UCH may be a dummy word lines. In such an example, data may not be stored in memory cells connected to the dummy word lines. Alternatively, the number of pages corresponding to the memory cells connected to the dummy word lines may be less than the number of pages corresponding to memory cells connected to a general word line. A voltage level applied to the dummy word line may be different from a voltage level applied to the general word line, thereby potentially reducing the influence of an uneven channel width between the lower channel LCH and upper channel UCH on the operation of the memory device.

Although FIG. 13 illustrates, in region A2, the number of lower word lines (e.g., the first word line 331 and the second word line 332) through which the lower channel LCH passes being less than the number of upper word lines (e.g., the third word line 333 to the eighth word line 338) through which the upper channel UCH passes, the present disclosure is not limited in this regard. For example, the number of lower word lines passing through the lower channel LCH may be equal to or greater than the number of upper word lines passing through the upper channel UCH. In addition, a structure and connection relationship of the channel structure CH located in the first cell region CELL1 described above may be equally applied to the channel structure CH located in the second cell region CELL2.

In the bit line bonding region BLBA, a first through-electrode THV1 may be provided in the first cell region CELL1 and a second through-electrode THV2 may be provided in the second cell region CELL2. As shown in FIG. 13, the first through-electrode THV1 may pass through the common source line 320 and the plurality of word lines 330. However, the present disclosure is not limited in this regard, and for example, the first through-electrode THV1 may further pass through the second substrate 310. The first through-electrode THV1 may include a conductive material. Alternatively or additionally, the first through-electrode THV1 may include a conductive material surrounded by an insulating material. The second through-electrode THV2 may also be provided in the same shape and structure as the first through-electrode THV1.

In an embodiment, the first through-electrode THV1 and the second through-electrode THV2 may be electrically connected through a first through-metal pattern 372d and a second through-metal pattern 472d. The first through-metal pattern 372d may be formed at a lower end of the first upper chip including the first cell region CELL1, and the second through-metal pattern 472d may be formed at an upper end of the second upper chip including the second cell region CELL2. The first through-electrode THV1 may be electrically connected to the first metal interconnection 350c and the second metal interconnection 360c. A lower via 371d may be formed between the first through-electrode THV1 and the first through-metal pattern 372d, and the upper via 471d may be formed between the second through-electrode THV2 and the second through-metal pattern 472d. The first through-metal pattern 372d may be connected to the second through-metal pattern 472d through a bonding method.

In addition, in the bit line bonding region BLBA, an upper metal pattern 252 may be formed on the uppermost metal layer of the peripheral circuit region PERI, and an upper metal pattern 392 having the same shape as that of the upper metal pattern 252 may be formed on the uppermost metal layer of the first cell region CELL1. The upper metal pattern 392 of the first cell region CELL1 may be electrically connected to the upper metal pattern 252 of the peripheral circuit region PERI through a bonding method. In the bit line bonding region BLBA, the second metal interconnection 360c may be electrically connected to a page buffer included in the peripheral circuit region PERI. For example, some of the circuit elements 220c of the peripheral circuit region PERI may provide a page buffer, and the second metal interconnection 360c may be electrically connected to the circuit elements 220c that provide a page buffer through the upper bonding metal 370c of the first cell region CELL1 and the upper bonding metal 270c of the peripheral circuit region PERI.

Continuing to refer to FIG. 13, in the word line bonding region WLBA, the word lines 330 of the first cell region CELL1 may extend in the second direction (the X-axis direction) parallel to the upper surface of the second substrate 310 and may be connected to the cell contact plugs 340 (e.g., a first cell contact plug 341, a second cell contact plug 342, to a sixth cell contact plug 346, and a seventh cell contact plug 347). A first metal interconnection 350b and a second metal interconnection 360b may be sequentially connected to upper portions of the cell contact plugs 340 connected to the plurality of word lines 330. In the word line bonding region WLBA, the cell contact plugs 340 may be connected to the peripheral circuit region PERI through the upper bonding metal 370b of the first cell region CELL1 and the upper bonding metal 270b of the peripheral circuit region PERI.

The cell contact plugs 340 may be electrically connected to a row decoder included in the peripheral circuit region PERI. For example, some of the circuit elements 220b of the peripheral circuit region PERI may provide a row decoder, and the cell contact plugs 340 may be electrically connected to the circuit elements 220b providing a low decoder through the upper bonding metal 370b of the first cell region CELL1 and the upper bonding metal 270b of the peripheral circuit region PERI. In an embodiment, an operating voltage of the circuit elements 220b providing the row decoder may be different from an operating voltage of the circuit elements 220c providing the page buffer. For example, the operating voltage of the circuit elements 220c that provide the page buffer may be greater than the operating voltage of the circuit elements 220b that provide the row decoder.

Similarly, in the word line bonding region WLBA, the plurality of word lines 430 of the second cell region CELL2 may extend in the second direction (the X-axis direction) parallel to an upper surface of the third substrate 410 and may be connected to a plurality of cell contact plugs 440 (e.g., a first cell contact plug 441, a second cell contact plug 442, to a sixth cell contact plug 446 and a seventh cell contact plug 447). The plurality of cell contact plugs 440 may be connected to the peripheral circuit region PERI through the upper metal pattern of the second cell region CELL2, the lower metal pattern and the upper metal pattern of the first cell region CELL1, and cell contact plug 348.

In the word line bonding region WLBA, the upper bonding metal 370b may be formed in the first cell region CELL1 and the upper bonding metal 270b may be formed in the peripheral circuit region PERI. The upper bonding metal 370b of the first cell region CELL1 may be electrically connected to the upper bonding metal 270b of the peripheral circuit region PERI through a bonding method. The upper bonding metal 370b and the upper bonding metal 270b may include, but not limited to, aluminum (Al), copper (Cu), or tungsten (W).

In the external pad bonding region PA, a lower metal pattern in a lower portion of the first cell region CELL1 and an upper metal pattern 472a may be formed in an upper portion of the second cell region CELL2. The lower metal pattern 371e of the first cell region CELL1 may be connected to the upper metal pattern 472a of the second cell region CELL2 by a bonding method in the external pad bonding region PA. Similarly, an upper metal pattern 372a may be formed in an upper portion of the first cell region CELL1, and an upper metal pattern 272a may be formed in an upper portion of the peripheral circuit region PERI. The upper metal pattern 372a of the first cell region CELL1 may be connected to the upper metal pattern 272a of the peripheral circuit region PERI by a bonding method.

Common source line contact plugs (e.g., a first common source line contact plug 380 and a second common source line contact plug 480) may be located in the external pad bonding region PA. The first and second common source line contact plugs 380 and 480 may include a conductive material, such as, but not limited to, a metal, a metal compound, or a doped polysilicon. The first common source line contact plug 380 of the first cell region CELL1 may be electrically connected to the common source line 320, and the second common source line contact plug 480 of the second cell region CELL2 may be electrically connected to the common source line 420. A first metal interconnection 350a and a second metal interconnection 360a may be sequentially stacked on the common source line contact plug 380 of the first cell region CELL1, and a first metal interconnection 450a and a second metal interconnection 460a may be sequentially stacked on the common source line contact plug 480 of the second cell region CELL2.

Input/output (I/O) pads (e.g., a first I/O pad 205, a second I/O pad 405, and a third I/O pad 406) may be located in the external pad bonding region PA. Referring to FIG. 13, a lower insulating film 201 may cover the lower surface of the first substrate 210, and the first I/O pad 205 may be formed on the lower insulating film 201. The first I/O pad 205 may be connected to at least one of the circuit elements 220a located in the peripheral circuit region PERI through the first I/O contact plug 203 and may be separated from the substrate 210 by the lower insulating film 201. In addition, a side insulating film may be located between the first I/O contact plug 203 and the first substrate 210 to electrically separate the first I/O contact plug 203 from the first substrate 210.

An upper insulating film 401 may be formed on the third substrate 410 to cover an upper surface of the third substrate 410. The second I/O pad 405 and/or the third I/O pad 406 may be disposed on the upper insulating film 401. The second I/O pad 405 may be connected to at least one of the circuit elements 220a located in the peripheral circuit region PERI through the second I/O contact plugs 403 and 303, and the third I/O pad 406 may be connected to at least one of the circuit elements 220a located in the peripheral circuit region PERI through the third I/O contact plugs 404 and 304.

In an embodiment, the third substrate 410 may not be located in a region in which the I/O contact plug is located. For example, as shown in regions B1 and B2, the third I/O contact plug 404 may be separated from the third substrate 410 in a direction parallel to the upper surface of the third substrate 410 and may be connected to the third I/O pad 406 through the interlayer insulating layer 415 of the second cell region CELL2. In such an example, the third I/O contact plug 404 may be formed through various processes.

As an example, as shown in region B1, the third I/O contact plug 404 may extend in the third direction (the Z-axis direction) and may be formed to have a diameter that increases toward the upper insulating film 401. That is, while the diameter of the channel structure CH described above regarding region A1 may be formed to decrease toward the upper insulating film 401, the diameter of the third I/O contact plug 404 may be formed to increase toward the upper insulating film 401. For example, the third I/O contact plug 404 may be formed after the second cell region CELL2 is coupled to the first cell region CELL1 by a bonding method.

In addition, as another example, as shown in region B2, the third I/O contact plug 404 may extend in the third direction (the Z-axis direction) and may be formed to have a diameter decreasing toward the upper insulating film 401. That is, the diameter of the third I/O contact plug 404 may be formed to decrease toward the upper insulating film 401, similar to the channel structure CH. For example, the third I/O contact plug 404 may be formed together with the cell contact plugs 440 before the second cell region CELL2 is bonded to the first cell region CELL1.

In another embodiment, the I/O contact plug may be located to overlap the third substrate 410. For example, as shown in regions C1, C2, and C3, the second I/O contact plug 403 may be formed to pass through the interlayer insulating layer 415 of the second cell region CELL2 in the third direction (the Z-axis direction) and may be electrically connected to the second I/O pad 405 through the third substrate 410. In such an example, a connection structure of the second I/O contact plug 403 and the second I/O pad 405 may be implemented in various manners.

As an example, as shown in region C1, an opening 408 may be formed to pass through the third substrate 410, and the second I/O contact plug 403 may be directly connected to the second I/O pad 405 through the opening 408 formed in the third substrate 410. In this case, as shown in region C1, the diameter of the second I/O contact plug 403 may be formed to increase toward the second I/O pad 405. However, the present is not limited in this regard, and the diameter of the second I/O contact plug 403 may be formed to decrease toward the second I/O pad 405.

As an example, as shown in region C2, the opening 408 may be formed to pass through the third substrate 410, and a contact 407 may be formed within the opening 408. One end of the contact 407 may be connected to the second I/O pad 405, and the other end may be connected to the second I/O contact plug 403. Accordingly, the second I/O contact plug 403 may be electrically connected to the second I/O pad 405 through the contact 407 within the opening 408. In this case, as shown in region C2, the diameter of the contact 407 may be formed to increase toward the second I/O pad 405, and the diameter of the second I/O contact plug 403 may be formed to decrease toward the second I/O pad 405. For example, the third I/O contact plug 403 may be formed together with the cell contact plugs 440 before the second cell region CELL2 is bonded to the first cell region CELL1, and the contact 407 may be formed after the second cell region CELL2 is bonded to the first cell region CELL1.

In addition, as an example, as shown in region C3, a stopper 409 may be further formed on an upper surface of the opening 408 of the third substrate 410, compared to C2. The stopper 409 may be a metal interconnection formed on the same layer as the common source line 420. However, the present disclosure is not limited in this regard, and the stopper 409 may be a metal interconnection formed on the same layer as at least one of the word lines 430. The second I/O contact plug 403 may be electrically connected to the second I/O pad 405 through the contact 407 and the stopper 409.

Similar to the second and third I/O contact plugs 403 and 404 of the second cell region CELL2, the second and third I/O contact plugs 303 and 304 of the first cell region CELL1 may each have a diameter decreasing or increasing toward the lower metal pattern 371e.

According to embodiments, a slit 411 may be formed in the third substrate 410. For example, the slit 411 may be formed at a certain location in the external pad bonding region PA. For example, as shown in regions D1, D2, and D3, the slit 411 may be located between the second I/O pad 405 and the cell contact plugs 440 in a plan view. However, the present disclosure is not limited in this regard, and the slit 411 may be formed so that the second I/O pad 405 is located between the slit 411 and the cell contact plugs 440 in a plan view.

As an example, as shown in region D1, the slit 411 may be formed to pass through the third substrate 410. For example, the slit 411 may be used to prevent the third substrate 410 from being finely cracked when the opening 408 is formed. However, the present disclosure is not limited in this regard, and the slit 411 may be formed to have a depth of about 60% to about 70% of the thickness of the third substrate 410.

In addition, as an example, as shown in region D2, a conductive material 412 may be formed in the slit 411. The conductive material 412 may be used, for example, to externally discharge leakage current occurring while circuit elements in the external pad bonding region PA are driven. In such an example, the conductive material 412 may be connected to an external ground line.

In addition, as an example, as shown in region D3, an insulating material 413 may be formed within the slit 411. For example, the insulating material 413 may be formed to electrically separate the second I/O pad 405 and the second I/O contact plug 403 located in the external pad bonding region PA from the word line bonding region WLBA. By forming the insulating material 413 in the slit 411, a voltage provided through the second I/O pad 405 may be prevented from affecting the metal layer disposed on the third substrate 410 in the word line bonding region WLBA.

According to embodiments, the first to third I/O pads 205 to 406 may be formed selectively. For example, the memory device 500 may be implemented to include only the first I/O pad 205 disposed on top of the first substrate 210, include only the second I/O pad 405 disposed on top of the third substrate 410, and/or include only the third I/O pad 406 disposed on top of the upper insulating film 401.

According to embodiments, at least one of the second substrate 310 of the first cell region CELL1 and the third substrate 410 of the second cell region CELL2 may be used as a sacrificial substrate and may be completely or partially removed before or after a bonding process. An additional film may be stacked after removal of the substrate. For example, the second substrate 310 of the first cell region CELL1 may be removed before or after bonding of the peripheral circuit region PERI to the first cell region CELL1, and an insulating film covering an upper surface of the common source line 320 or a conductive film for connection may be formed. Similarly, the third substrate 410 of the second cell region CELL2 may be removed before or after bonding of the first cell region CELL1 to the second cell region CELL2, and an upper insulating film 401 covering the upper surface of the common source line 420 or a conductive film for connection may be formed.

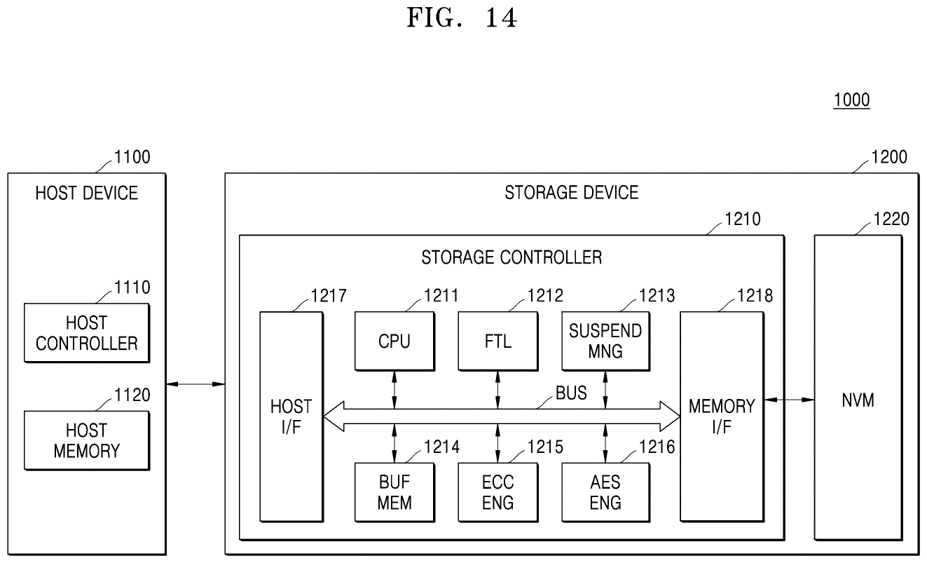

FIG. 14 is a block diagram of a storage system 1000 according to an example embodiment.

The storage system 1000 may include a host device 1100 and a storage device 1200. The storage device 1200 may be the memory system 10 of FIG. 1. The storage device 1200 may include the memory controller 100 and the memory device 200 described with reference to FIGS. 1 to 13. The storage device 1200 may perform the operations or functions described with reference to FIGS. 1 to 13. Further, the storage device 1200 may include a storage controller 1210 and an NVM 1220. The storage controller 1210 may be the memory controller 100 of FIG. 1. The NVM 1220 may be the memory device 200 of FIG. 1. According to an example embodiment, the host device 1100 may include a host controller 1110 and a host memory 1120. The host memory 1120 may serve as a buffer memory configured to temporarily store data to be transmitted to the storage device 1200 or data received from the storage device 1200.

The storage device 1200 may include storage media configured to store data in response to requests from the host device 1100. As an example, the storage device 1200 may include at least one of an SSD, an embedded memory, and a removable external memory. When the storage device 1200 is an SSD, the storage device 1200 may be a device that conforms to an NVMe standard. When the storage device 1200 is an embedded memory or an external memory, the storage device 1200 may be a device that conforms to a UFS standard or an eMMC standard. Each of the host device 1100 and the storage device 1200 may generate a packet according to an adopted standard protocol and transmit the packet.

When the NVM 1220 of the storage device 1200 includes a flash memory, the flash memory may include a 2D NAND memory array or a 3D (or vertical) NAND (VNAND) memory array. As another example, the storage device 1200 may include various other kinds of NVMs. For example, the storage device 1200 may include magnetic RAM (MRAM), spin-transfer torque MRAM, conductive bridging RAM (CBRAM), ferroelectric RAM (FRAM), PRAM, RRAM, and various other kinds of memories.

According to an embodiment, the host controller 1110 and the host memory 1120 may be implemented as separate semiconductor chips. Alternatively, in some embodiments, the host controller 1110 and the host memory 1120 may be integrated in the same semiconductor chip. As an example, the host controller 1110 may be any one of a plurality of modules included in an application processor (AP). The AP may be implemented as a System on Chip (SoC). Further, the host memory 1120 may be an embedded memory included in the AP or an NVM or memory module located outside the AP.

The host controller 1110 may manage an operation of storing data (e.g., write data) of a buffer region of the host memory 1120 in the NVM 1220 or an operation of storing data (e.g., read data) of the NVM 1220 in the buffer region.

The storage controller 1210 may include a host interface 1217, a memory interface 1218, and a CPU 1211. Further, the storage controller 1210 may further include a flash translation layer (FTL) 1212, a suspend manager 1213, a buffer memory 1214, an error correction code (ECC) engine 1215, and an advanced encryption standard (AES) engine 1216. The storage controller 1210 may further include a working memory (not shown) in which the FTL 1212 is loaded. The CPU 1211 may execute the FTL 1212 to control data write and read operations on the NVM 1220. The storage controller 1210 may further include a packet manager (not shown).

The host interface 1217 may transmit and receive packets to and from the host device 1100. A packet transmitted from the host device 1100 to the host interface 1217 may include a command or data to be written to the NVM 1220. A packet transmitted from the host interface 1217 to the host device 1100 may include a response to the command or data read from the NVM 1220. The memory interface 1218 may transmit data to be written to the NVM 1220 to the NVM 1220 or receive data read from the NVM 1220. The memory interface 1218 may be configured to comply with a standard protocol, such as Toggle or open NAND flash interface (ONFI).

The FTL 1212 may perform various functions, such as an address mapping operation, a wear-leveling operation, and a garbage collection operation. The address mapping operation may be an operation of converting a logical address received from the host device 1100 into a physical address used to actually store data in the NVM 1220. The wear-leveling operation may be a technique for preventing excessive deterioration of a specific block by allowing blocks of the NVM 1220 to be uniformly used. As an example, the wear-leveling operation may be implemented using a firmware technique that balances erase counts of physical blocks. The garbage collection operation may be a technique for ensuring usable capacity in the NVM 1220 by erasing an existing block after copying valid data of the existing block to a new block.

The packet manager may generate a packet according to a protocol of an interface, which consents to the host device 1100, or parse various types of information from the packet received from the host device 1100. In addition, the buffer memory 1214 may temporarily store data to be written to the NVM 1220 or data to be read from the NVM 1220. Although the buffer memory 1214 may be a component included in the storage controller 1210, the buffer memory 1214 may be outside the storage controller 1210.

The ECC engine 1215 may perform error detection and correction operations on read data read from the NVM 1220. More specifically, the ECC engine 1215 may generate parity bits for write data to be written to the NVM 1220, and the generated parity bits may be stored in the NVM 1220 together with write data. During the reading of data from the NVM 1220, the ECC engine 1215 may correct an error in the read data by using the parity bits read from the NVM 1220 along with the read data, and output error-corrected read data.

The AES engine 1216 may perform at least one of an encryption operation and a decryption operation on data input to the storage controller 1210 by using a symmetric-key algorithm.

In one embodiment, the host device 1100 may transmit suspend information to the storage device 1200. For example, the suspend information may include information about a suspend mode, information about a suspend delay time, information about a resume delay time, or information about a read pattern. The host device 1100 may change the suspend mode of the storage device 1200 through the suspend information. Alternatively, the host device 1100 may cause the storage device 1200 to adjust the suspend delay time or the resume delay time through the suspend information.

The storage controller 1210 may perform a suspend operation. The suspend operation may refer to an operation of stopping a program operation or an erase operation that is being performed. In one embodiment, for scheduling requests received from the host device 1100, the storage controller 1210 may transmit a suspend command or a resume command to the NVM 1220.

The storage controller 1210 may suspend the program operation being performed by transmitting a suspend command to the NVM 1220. The storage controller 1210 may perform a read operation first while the program operation is suspended. The storage controller 1210 may transmit a read command to the NVM 1220, receive read data, and provide the read data to the host device 1100. That is, the storage controller 1210 may process a read request before a write request. In order to reduce read latency, the storage controller 1210 may suspend the program operation being performed and first process a read request received from the host device 1100. Thereafter, the storage controller 1210 may transmit a resume command to resume the suspended program operation.

The NVM 1220 may suspend the operation being performed in response to the suspend command. The NVM 1220 may transmit read data to the storage controller 1210 in response to the read command. The NVM 1220 may resume the suspended operation in response to the resume command.

In one embodiment, the storage controller 1210 may perform a monitoring operation. The monitoring operation may refer to an operation of monitoring and analyzing an input/output pattern for the NVM 1220 for a predetermined period of time. The storage controller 1210 may monitor a suspend pattern or an input/output pattern. The storage controller 1210 may analyze a suspend pattern or an input/output pattern.

For example, the storage controller 1210 may determine whether there are more read operations than write operations during a predetermined time period. The storage controller 1210 may determine whether there are more read commands transmitted to the NVM 1220 than write commands. The storage controller 1210 may measure an average read latency during a predetermined time period. The storage controller 1210 may count the number of read commands transmitted during a predetermined time period. The storage controller 1210 may count the number of read commands processed during one suspend operation.

In one embodiment, the storage controller 1210 may receive suspend information from the host device 1100. For example, the storage controller 1210 may receive the suspend information via a set-feature command. For example, the suspend information may include information about a suspend mode, information about a suspend delay time, information about a resume delay time, or information about a read pattern.

In one embodiment, the storage controller 1210 may adjust the suspend delay time or the resume delay time based on the monitoring result or the analysis result. In one embodiment, the storage controller 1210 may adjust the suspend delay time or the resume delay time based on the suspend information received from the host device 1100.

The storage controller 1210 may adjust the suspend delay time or the resume delay time so that multiple read commands may be processed simultaneously. The storage controller 1210 may utilize the interleaving function of the NVM 1220 by processing multiple read commands simultaneously. Accordingly, the storage controller 1210 may improve performance.

In one embodiment, the storage controller 1210 may immediately transmit (or issue) a suspend command in response to a read request received from the host device 1100. Alternatively, the storage controller 1210 may immediately schedule a suspend command in response to a read request received from the host device 1100. For example, the storage controller 1210 may queue the suspend command in a queue that queues commands to be transmitted to the NVM 1220.

In one embodiment, the storage controller 1210 may, in response to a read request received from the host device 1100, transmit or schedule a suspend command after a suspend delay time from the time of receiving the read request. The suspend delay time may be a predetermined time. The storage controller 1210 may adjust the suspend delay time. The storage controller 1210 may increase or decrease the suspend delay time. For example, the storage controller 1210 may determine the suspend latency.

For example, the storage controller 1210 may increase the suspend delay time when the number of read commands is greater than the number of write commands. Alternatively, the storage controller 1210 may increase the suspend delay time when the number of read commands exceeds a predetermined threshold for a predetermined time. Alternatively, the storage controller 1210 may increase the suspend delay time when the average read latency exceeds a predetermined threshold. Alternatively, the storage controller 1210 may increase the suspend delay time when the number of read commands processed during one suspend operation exceeds a predetermined threshold.

For example, the storage controller 1210 may decrease the suspend delay time when the number of read commands is less than the number of write commands. Alternatively, the storage controller 1210 may decrease the suspend delay time when the number of read commands is less than or equal to a predetermined threshold value for a predetermined time period. Alternatively, the storage controller 1210 may decrease the suspend delay time when the average read latency is less than or equal to a predetermined threshold value. Alternatively, the storage controller 1210 may decrease the suspend delay time when the number of read commands processed during one suspend operation is less than or equal to a predetermined threshold value.

In one embodiment, the storage controller 1210 may immediately transmit (or issue) a resume command in response to read data received from the NVM 1220. Alternatively, the storage controller 1210 may immediately schedule a resume command in response to read data received from the NVM 1220. For example, the storage controller 1210 may queue the resume command in a queue that queues commands to be transmitted to the NVM 1220.

In one embodiment, the storage controller 1210 may, in response to read data received from the NVM 1220, transmit or schedule a resume command after a resume delay time from the time of receiving the read data. The resume delay time may be a predetermined time. The storage controller 1210 may adjust the resume delay time. The storage controller 1210 may increase or decrease the resume delay time. For example, the storage controller 1210 may determine the resume delay time.

For example, the storage controller 1210 may increase the resume delay time when the number of read commands is greater than the number of write commands. Alternatively, the storage controller 1210 may increase the resume delay time when the number of read commands exceeds a predetermined threshold for a predetermined time. Alternatively, the storage controller 1210 may increase the resume delay time when the average read latency exceeds a predetermined threshold. Alternatively, the storage controller 1210 may increase the resume delay time when the number of read commands processed during one suspend operation exceeds a predetermined threshold.

For example, the storage controller 1210 may decrease the resume delay time when the number of read commands is less than the number of write commands. Alternatively, the storage controller 1210 may decrease the resume delay time when the number of read commands is less than or equal to a predetermined threshold value for a predetermined time period. Alternatively, the storage controller 1210 may decrease the resume delay time when the average read latency is less than or equal to a predetermined threshold value. Alternatively, the storage controller 1210 may decrease the resume delay time when the number of read commands processed during one suspend operation is less than or equal to a predetermined threshold value.

As described above, the storage controller 1210 may adjust the suspend delay time or the resume delay time. Accordingly, the storage controller 1210 may prevent the suspend operation from occurring frequently. The storage controller 1210 may decrease the number of occurrences of the suspend operation. The storage controller 1210 may improve the performance of the storage device 1200 by processing multiple read commands simultaneously. The storage device 1200 may improve both the read performance and the write performance. That is, the storage device 1200 may improve the mixed performance. The storage device 1200 may reduce the read latency. The storage device 1200 may improve the overall throughput.

Aspects of the present disclosure may provide a memory system that potentially increases data throughput without causing a latency in a data read operation, when compared to related memory systems, by analyzing patterns of read operation commands and write operation commands in real time and appropriately scheduling suspend operations.

The above description is merely illustrative of the present disclosure, and those skilled in the art are to understand that various modifications and changes may be made without departing from the essential characteristics of the present disclosure. Accordingly, the disclosed embodiments are for illustrative purposes rather than limiting the technical idea described in the present disclosure, and the scope of the present disclosure is not limited by the disclosed embodiments. The scope of the present disclosure according to the disclosed embodiments should be interpreted in accordance with the claims below, and all technical ideas within the equivalent scope should be interpreted as being included in the scope of the disclosed present disclosure.

What is claimed is:

1. A memory system, comprising:
a memory device; and
a memory controller connected to the memory device,
wherein the memory controller is configured to:
analyze a pattern of the suspend schedule command a plurality of times to obtain a plurality of analysis results;
select an operating mode from among a plurality of operating modes based on the plurality of analysis results, the plurality of operating modes comprising a latency mode and a throughput mode;
determine a suspend schedule based on the operating mode; and
perform a memory operation on the memory device based on the suspend schedule, the memory operation comprising at least one of a read operation or a write operation.

2. The memory system of claim 1, wherein the memory controller is further configured to identify a suspend pattern included in the suspend schedule command.

3. The memory system of claim 1, wherein the memory controller is further configured to change the suspend schedule in real time.

4. The memory system of claim 3, wherein the memory controller is further configured to determine, based on the changing of the suspend schedule, a suspend latency based on a preset reference.

5. The memory system of claim 3, wherein the memory controller is further configured to determine, based on the changing of the suspend schedule, a write resume time point latency based on a preset reference.

6. The memory system of claim 1, wherein the memory controller is further configured to:
based on a determination that a number of read operations is greater than a number of write operations based on the analysis of the pattern of the suspend schedule command:
determine the suspend schedule based on the throughput mode; and
determine the suspend schedule by grouping the read operations.

7. The memory system of claim 1, wherein the memory controller is further configured to:
based on a determination that a number of read operations is less than a number of write operations based on the analysis of the pattern of the suspend schedule command:
determine the suspend schedule based on the latency mode; and
determine the suspend schedule, and maintain a pattern of the read operations.

8. An operating method of a memory system for managing a suspend schedule of a memory device, the operating method comprising:
analyzing a pattern of the suspend schedule command a plurality of times to obtain a plurality of analysis results;
selecting an operating mode from among a plurality of operating modes based on the plurality of analysis results, the plurality of operating modes comprising a latency mode and a throughput mode;
determining a suspend schedule based on the operating mode; and
performing a memory operation on the memory device based on the suspend schedule, the memory operation comprising at least one of a read operation or a write operation.

9. The operating method of claim 8, wherein the determining of the suspend schedule comprises identifying a suspend pattern included in the suspend schedule command.

10. The operating method of claim 8, wherein the determining of the suspend schedule further comprises changing the suspend schedule in real time.

11. The operating method of claim 10, wherein the determining of the suspend schedule further comprises determining, based on the changing of the suspend schedule, a suspend latency based on a preset reference.

12. The operating method of claim 10, wherein the determining of the suspend schedule further comprises determining, based on the changing of the suspend schedule, a write resume time point latency based on a preset reference.

13. The operating method of claim 8, wherein the determining of the suspend schedule further comprises determining the suspend schedule based on the throughput mode, based on determining that a number of read operations is greater than a number of write operations based on the pattern of the suspend schedule command,
wherein the suspend schedule is further determined by grouping the read operations.

14. The operating method of claim 8, wherein the determining of the suspend schedule further comprises determining the suspend schedule based on the latency mode based on determining that a number of read operations is less than a number of write operations based on the pattern of the suspend schedule command, and
wherein the suspend schedule is determined to maintain a pattern of the read operations.

15. An operating method of a memory controller in a memory system for managing a suspend schedule of a memory device, the operating method comprising:
analyzing a pattern of the suspend schedule command a plurality of times to obtain a plurality of analysis results;
selecting an operating mode from among a plurality of operating modes based on the plurality of analysis results, the plurality of operating modes comprising a latency mode and a throughput mode;
determining a suspend schedule based on the operating mode; and
performing a memory operation on the memory device based on the suspend schedule, the memory operation comprising at least one of a read operation or a write operation.

16. The operating method of claim 15, wherein the determining of the suspend schedule comprises identifying a suspend pattern included in the suspend schedule command.

17. The operating method of claim 15, wherein the determining of the suspend schedule further comprises changing the suspend schedule in real time.

18. The operating method of claim 17, wherein the determining of the suspend schedule further comprises determining, based on the changing of the suspend schedule, at least one of a suspend latency or a write resume time point latency based on a preset reference.

19. The operating method of claim 15, wherein the determining of the suspend schedule further comprises:
determining the suspend schedule based on the throughput mode, based on determining that a number of read operations is greater than a number of write operations based on the pattern of the suspend schedule command, and
determining the suspend schedule by grouping the read operations.

20. The operating method of claim 15, wherein the determining of the suspend schedule further comprises:
determining the suspend schedule based on the latency mode based on determining that a number of read operations is less than a number of write operations based on the pattern of the suspend schedule command, and
determining the suspend schedule, and maintaining a pattern of the read operations.
